(19) United States
(12) Patent Application Publication
(10) Pub. No.: US 2025/0036933 A1
(43) Pub. Date: Jan. 30, 2025

(54) DYNAMIC COMPRESSION AND SPECIALIZATION OF A MACHINE LEARNING MODEL

(71) Applicant: Cisco Technology, Inc., San Jose, CA (US)

(72) Inventors: Gaowen Liu, Austin, TX (US); Ramana Rao V.R. KOMPELLA, Foster City, CA (US)

(21) Appl. No.: 18/225,371

(22) Filed: Jul. 24, 2023

(51) Int. Cl. G06N 3/08

(52) U.S. Cl. CPC G06N 3/08

(57) ABSTRACT

In one embodiment, a device identifies a plurality of tasks that a base machine learning model is able to perform. The device receives, via a user interface, a request to generate a specialized model to perform a particular task for deployment to a target deployment environment. The device uses knowledge distillation on the base machine learning model to train the specialized model to perform the particular task based on at least one of the plurality of tasks. The device causes the specialized model to be deployed to the target deployment environment.

### TECHNICAL FIELD

The present disclosure relates generally to computer networks, and, more particularly, to the dynamic compression and specialization of a machine learning model.

### BACKGROUND

Neural networks and other forms of machine learning models have proven to be quite capable of performing a large variety of tasks. For instance, machine learning is increasingly being used in the field of video analytics for purposes of tasks such as object detection, object or behavior classification, and the like. Doing so has a wide variety of use cases ranging from medical imaging to surveillance systems, among others.

For instance, person/object detection and reidentification now allows for a specific person or object to be detected and/or tracked across different video feeds throughout a location. More advanced video analytics techniques also attempt to detect certain types of events/activities, such as a person leaving a suspicious package in an airport, people fighting, etc. Underlying such functionality are machine learning (ML)/deep learning (DL) models that have been trained using a set of training data that include examples of the objects or activities to be detected by the model.

One tradeoff to the use of ML models is that many models can be computationally intensive, making their training and execution unsuitable for certain devices. Indeed, the more capable the model, the more resources that it consumes during its training, as well as its execution. For instance, training a model to detect hundreds of different types of objects or behaviors will result in a model that is much larger and resource consuming than one that is only trained to detect a dozen different types of objects or behaviors. Depending on the deployment use case, though, a more capable model may be overkill for its intended use, thereby consuming additional computational resources (e.g., processing power, memory and storage capacity, virtual computing resources, etc.), unnecessarily. Unfortunately, available ML models are one-size-fits-all offerings that force users to use resource-intensive models with a broad range of capabilities to accomplish specific, narrow tasks.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate an example of a computer network;

FIG. 2 illustrates an example of a network device/node;

FIG. 3 illustrates an example of a knowledge distillation architecture for the dynamic compression and specialization of a machine learning model;

FIG. 4 illustrates an example of an architecture for the dynamic compression and specialization of a machine learning model;

FIG. 5 illustrates an example of an interface for the dynamic compression and specialization of a machine learning model;

FIG. 6 illustrates examples of model testing results for dynamically compressed and specialized machine learning models; and

FIG. 7 illustrates an example of a simplified procedure for the dynamic compression and specialization of a machine learning model.

### DESCRIPTION OF EXAMPLE EMBODIMENTS

### Overview

According to one or more embodiments of the disclosure, a device identifies a plurality of tasks that a base machine learning model is able to perform. The device receives, via a user interface, a request to generate a specialized model to perform a particular task for deployment to a target deployment environment. The device uses knowledge distillation on the base machine learning model to train the specialized model to perform the particular task based on at least one of the plurality of tasks. The device causes the specialized model to be deployed to the target deployment environment.

Description

A computer network is a geographically distributed collection of nodes interconnected by communication links and segments for transporting data between end nodes, such as personal computers, cellular phones, workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to forward data from one network to another.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform other actions.

Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

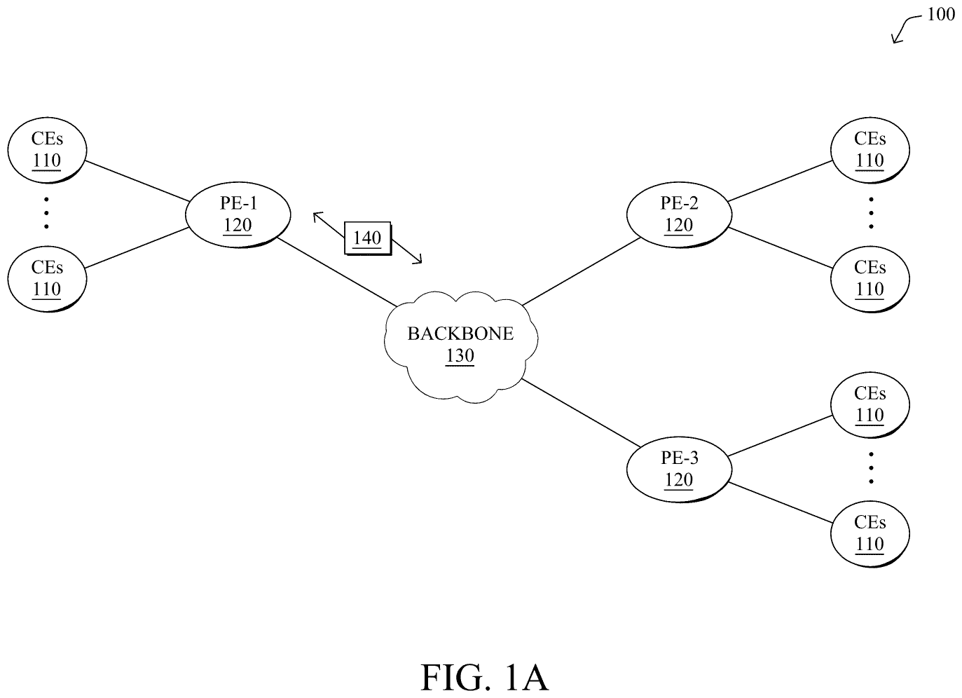

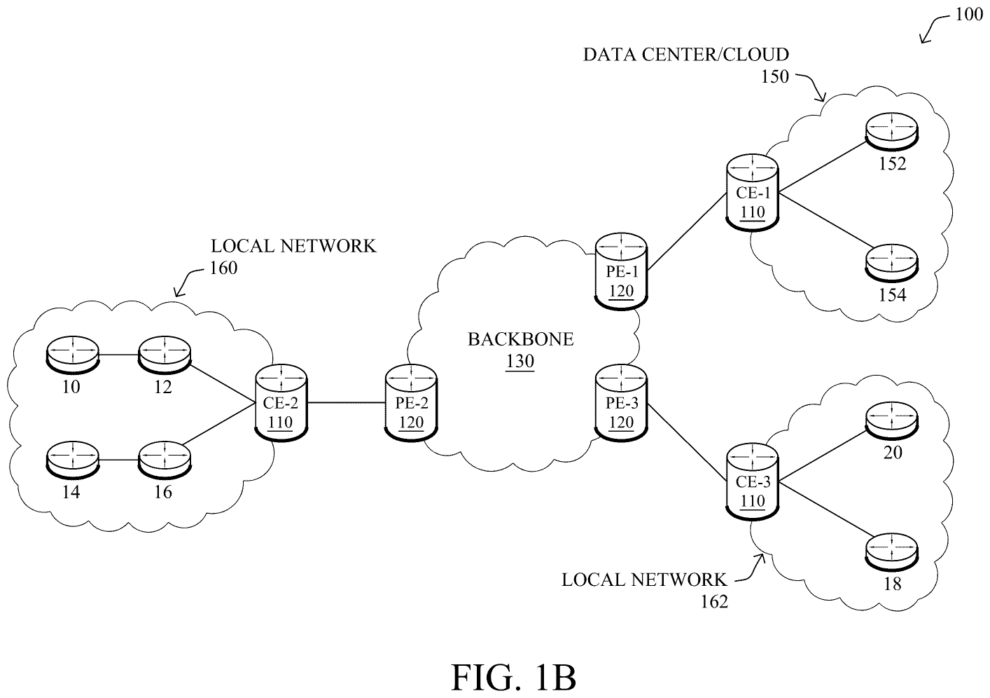

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public

Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN utilizing a Service Provider network, via one or more links exhibiting very different network and service level agreement characteristics. For the sake of illustration, a given customer site may fall under any of the following categories:

1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.

2.) Site Type B: a site connected to the network using two MPLS VPN links (e.g., from different Service Providers) using a single CE router, with potentially a backup link (e.g., a 3G/4G/5G/LTE connection). A site of type B may itself be of different types:

2a.) Site Type B1: a site connected to the network using two MPLS VPN links (e.g., from different Service Providers), with potentially a backup link (e.g., a 3G/4G/5G/LTE connection).

2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.

2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement or a loose service level agreement (e.g., a “Gold Package” Internet service connection that guarantees a certain level of performance to a customer site).

3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various embodiments. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

In various embodiments, network 100 may include one or more mesh networks, such as an Internet of Things network. Loosely, the term “Internet of Things” or “IoT” refers to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, heating, ventilating, and air-conditioning (HVAC), windows and window shades and blinds, doors, locks, etc. The “Internet of Things” thus generally refers to the interconnection of objects (e.g., smart objects), such as sensors and actuators, over a computer network (e.g., via IP), which may be the public Internet or a private network.

Notably, shared-media mesh networks, such as wireless or PLC networks, etc., are often deployed on what are referred to as Low-Power and Lossy Networks (LLNs), which are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen to thousands or even millions of LLN routers, and support point-to-point traffic (between devices inside the LLN), point-to-multipoint traffic (from a central control point such at the root node to a subset of devices inside the LLN), and multipoint-to-point traffic (from devices inside the LLN towards a central control point). Often, an IoT network is implemented with an LLN-like architecture. For example, as shown, local network 160 may be an LLN in which CE-2 operates as a root node for devices/nodes 10-16 in the local mesh, in some embodiments.

In contrast to traditional networks, LLNs face a number of communication challenges. First, LLNs communicate over a physical medium that is strongly affected by environmental conditions that change over time. Some examples include temporal changes in interference (e.g., other wireless networks or electrical appliances), physical obstructions (e.g., doors opening/closing, seasonal changes such as the foliage density of trees, etc.), and propagation characteristics of the physical media (e.g., temperature or humidity changes, etc.). The time scales of such temporal changes can range between milliseconds (e.g., transmissions from other transceivers) to months (e.g., seasonal changes of an outdoor environment). In addition, LLN devices typically use low-cost and low-power designs that limit the capabilities of their transceivers. In particular, LLN transceivers typically provide low throughput. Furthermore, LLN transceivers typically support limited link margin, making the effects of interference and environmental changes visible to link and network protocols. The high number of nodes in LLNs in comparison to traditional networks also makes routing, quality of service (QOS), security, network management, and traffic engineering extremely challenging, to mention a few.

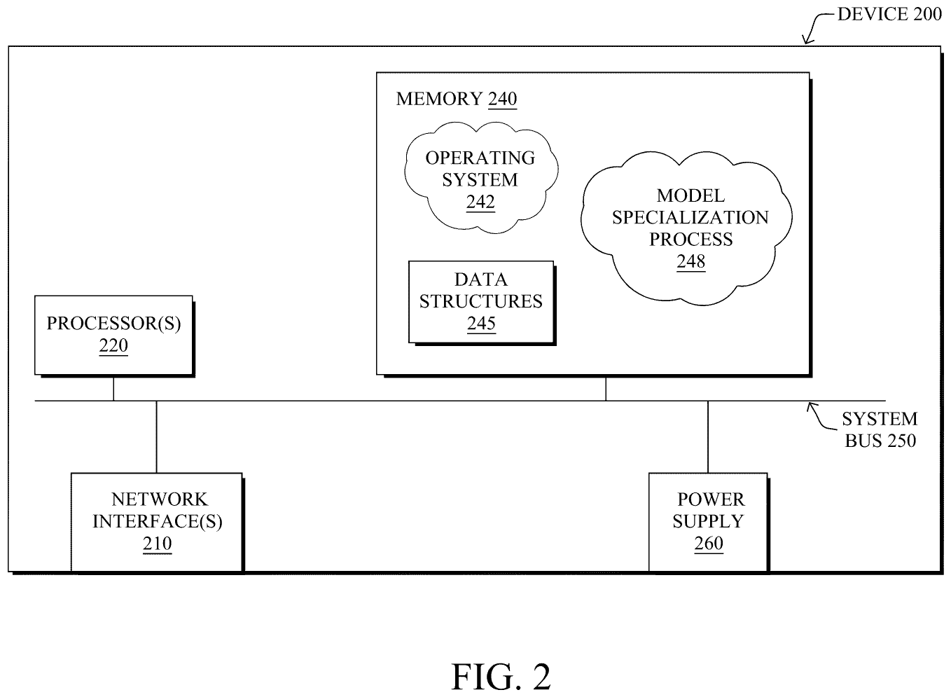

FIG. 2 is a schematic block diagram of an example node/device 200 (e.g., an apparatus) that may be used with one or more embodiments described herein, e.g., as any of the computing devices shown in FIGS. 1A-1B, particularly the PE routers 120, CE routers 110, nodes/device 10-20, servers 152-154 (e.g., a network controller located in a data center, etc.), any other computing device that supports the operations of network 100 (e.g., switches, etc.), or any of the other devices referenced below. In some examples, device 200 may be a device associated with performing and/or monitoring surveillance operations and/or a device communicatively coupled thereto. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise a model specialization process 248, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

Model specialization process 248 includes computer executable instructions that, when executed by processor(s) 220, cause device 200 to engage in the configuration, creation, training, and/or deployment of targeted ML models which may be associated with video analytics, among other things. In various embodiments, model specialization process 248 may utilize artificial intelligence/machine learning techniques, in whole or in part, to perform its analysis and reasoning functions. In general, machine learning is concerned with the design and the development of techniques that take as input empirical data (such as network statistics and performance indicators) and recognize complex patterns in these data. One very common pattern among machine learning techniques is the use of an underlying model M, whose hyper-parameters are optimized for minimizing the cost function associated to M. given the input data. The learning process then operates by adjusting the hyper-parameters such that the number of misclassified points is minimal. After this optimization phase (or learning phase), the model M can be used very easily to classify new data points. Often, M is a statistical model, and the minimization of the cost function is equivalent to the maximization of the likelihood function, given the input data.

In various embodiments, model specialization process 248 may employ one or more supervised, unsupervised, or self-supervised machine learning models. Generally, supervised learning entails the use of a training large set of data, as noted above, that is used to train the model to apply labels to the input data. For example, in the case of video recognition and analysis, the training data may include sample video data that depicts a certain object and is labeled as such. On the other end of the spectrum are unsupervised techniques that do not require a training set of labels. Notably, while a supervised learning model may look for previously seen patterns that have been labeled as such, an unsupervised model may instead look to whether there are sudden changes in the behavior. Self-supervised is a representation learning approach that eliminates the pre-requisite requiring humans to label data. Self-supervised learning systems extract and use the naturally available relevant context and embedded metadata as supervisory signals. Self-supervised learning models take a middle ground approach: it is different from unsupervised learning as systems do not learn the inherent structure of data, and it is different from supervised learning as systems learn entirely without using explicitly-provided labels.

Example machine learning techniques that model specialization process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), multi-layer perceptron (MLP) artificial neural networks (ANNs) (e.g., for non-linear models), replicating reservoir networks (e.g., for non-linear models, typically for time series), random forest classification, or the like. Accordingly, model specialization process 248 may employ deep learning, in some embodiments. Generally, deep learning is a subset of machine learning that employs ANNs with multiple layers, with a given layer extracting features or transforming the outputs of the prior layer.

The performance of a ML model can be evaluated in a number of ways based on the number of true positives, false positives, true negatives, and/or false negatives of the model. For example, the false positives of the model may refer to the number of times the model incorrectly identified an object or condition within a video feed. Conversely, the false negatives of the model may refer to the number of times the model failed to identify an object or condition within a video feed. True negatives and positives may refer to the number of times the model correctly determined that the object or condition was absent in the video or was present in the video, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

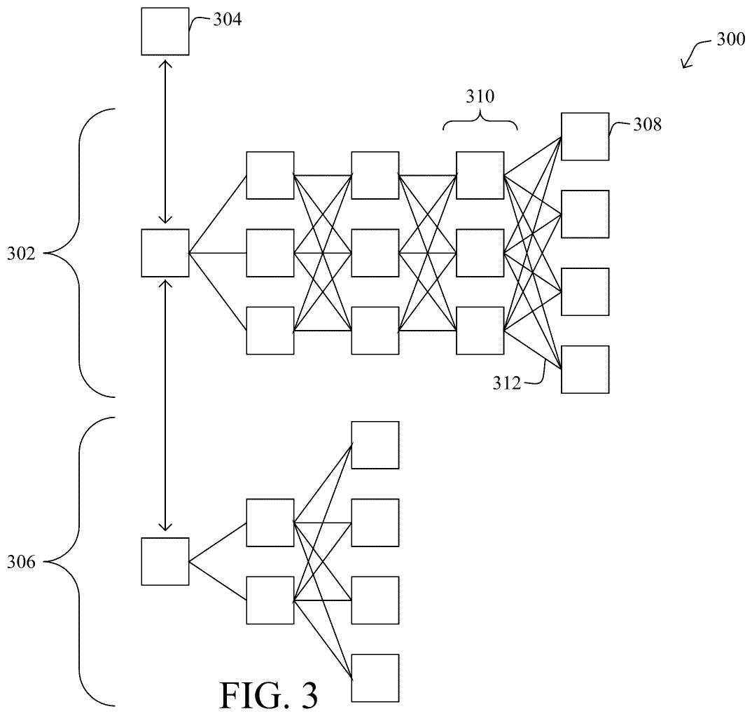

According to various embodiments, FIG. 3 illustrates an architecture 300 for the dynamic compression and specialization of a machine learning model. As the complexity and capability of ML models such as those used in video analytics has skyrocketed, so too has the computational burden of training, using, and/or maintaining these models. For example, while the more complex ML models are equipped with more predictive power, these improved models necessitate a longer training time, a longer inference time, larger memory and other computational resource usage, etc. Increasingly, there is a demand for these ML models to be applied at resource constrained devices (e.g., IoT devices, offline devices, etc.). Strategies for model compression may facilitate such applications.

For example, one strategy for model compression is pruning. One approach to pruning can include pruning (e.g., removing) weights 312 from an ML model. Additionally, neurons 308 or even entire layers 310 may be pruned from an ML model. Pruning techniques, however, can lead to sparse matrices, which may cause some computational difficulty.

Another strategy for model compression is quantization. While the aforementioned pruning may attempt to remove less-important weights, quantization seeks to reduce the number of bits required to store the weights. For example, binary quantization may be applied to stored weights in two states, leading to model compression. This approach may exacerbate the impact of vanishing/exploding gradients and therefore perform poorly on complex models like RNNs and LSTMs. In some instances, ternary quantization may be used to store three states, rather than two.

Yet another strategy for model compression is knowledge distillation. In knowledge distillation, a teacher ML model 302 may be trained on a data set 304. Then, a student ML model 306 may be trained to mimic the teacher ML model 302. This process may occur in a similar manner to pruning, but the characteristics of the student ML model 306 may be decided in advance instance of inferred as they are in pruning. The student ML model 306 may be involved in a regression task where it tries to replicate the intermediate representations of the model's confidence or evidence for each class before the probabilities are computed using the SoftMax function of the teacher ML model 302. By mimicking these logits of the teacher ML model 302, the student ML model 306 aims to learn the same function that the teacher model has learned from the data. This means that the student model tries to capture the knowledge and insights encoded in the teacher's predictions.

These examples of ML model compression techniques and others may be employed by the disclosed mechanisms for the dynamic compression and specialization of a ML model. That is, ML model compression techniques may be used to apply compression to an input model that serves as the basis for the target specialized ML model. For example, the ML model compression techniques may be used as a model compression mechanism applied to a teacher ML model 302 to compress it to a specialized version of the student ML model 306. Additionally, or alternatively, the student ML model 306 resulting from knowledge distillation may be used as the input ML model for the dynamic compression and specialization.

As noted above, many use cases for an ML model may only require the model to perform very specialized tasks. As a result, the use of a more generalized model in these applications carries with it ultimately unutilized capacity and complexity that is unnecessarily consuming (e.g., with respect to performing the specialized task) additional computational resources. In contrast, the techniques described herein introduce an à la carte approach to ML model configuration, training, and/or compression that facilitates dynamic spawning of specialized and streamlined ML models from larger, more computationally intensive, and generic input models. For instance, the described techniques facilitate training of a model using portions of an input model that are devoted to and/or necessary for accomplishing a specialized task of interest (e.g., identifying specific elements within a video feed, etc.), while discarding the portions of that input model that are not so devoted and/or necessary.

### Dynamic Compression and Specialization of a Machine Learning Model

The techniques herein allow for the dynamic compression and specialization of a machine learning model to perform specific, defined tasks, while reducing the resource requirements of the model.

Illustratively, the techniques described herein may be performed by hardware, software, and/or firmware, such as in accordance with model specialization process 248, which may include computer executable instructions executed by the processor 220 (or independent processor of interfaces 210), to perform functions relating to the techniques described herein.

Specifically, according to various embodiments, a device identifies a plurality of tasks that a base machine learning model is able to perform. The device receives, via a user interface, a request to generate a specialized model to perform a particular task for deployment to a target deployment environment. The device uses knowledge distillation on the base machine learning model to train the specialized model to perform the particular task based on at least one of the plurality of tasks. The device causes the specialized model to be deployed to the target deployment environment.

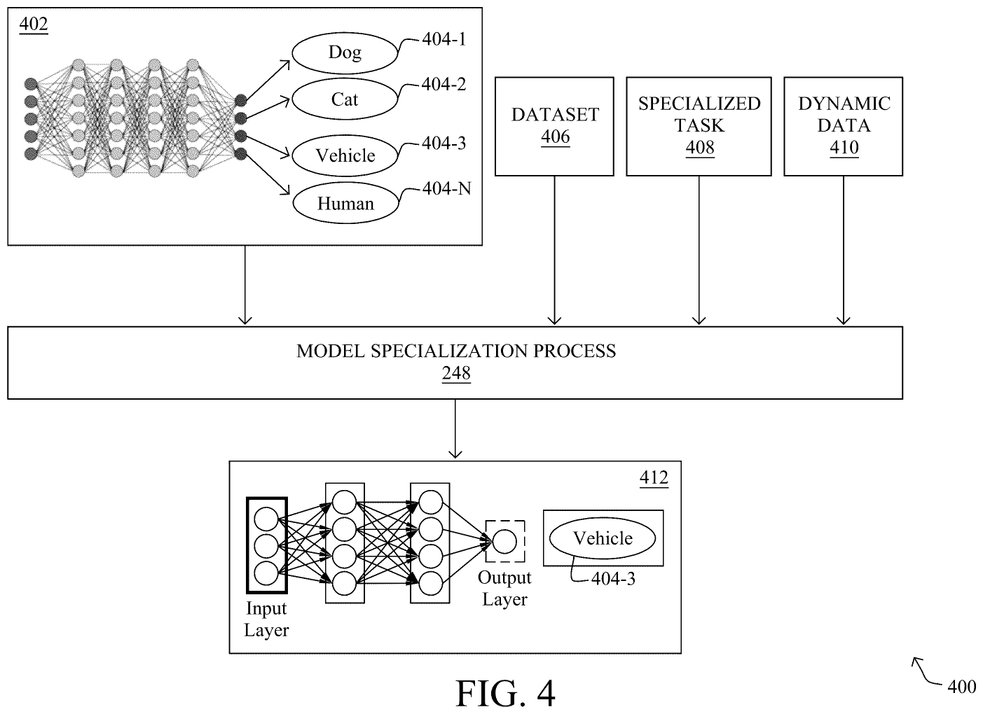

Operationally, FIG. 4 illustrates an example of an architecture 400 for the dynamic compression and specialization of a machine learning model, according to various embodiments. Architecture 400 may center around model specialization process 248. Model specialization process 248 may be executed to facilitate the training of a targeted ML model 412 having a targeted specialization (e.g., a focus on identifying a particular element such as element 404-3) from an input ML model 402. Specifically, model specialization process 248 may selectively utilize portions of an input ML model 402 associated with the targeted specialization to train a targeted ML model 412 for the specialized task, while discarding other portions of input ML model 402. In some embodiments, the other portions may be discarded from the targeted ML model 402 after training and/or during initial or additional model compression operations.

The input ML model 402 may be a large ML model that has been extensively trained to perform a wide variety of tasks on a relatively large training dataset. For instance, input ML model 402 may be a neural network (e.g., a convolutional neural network, etc.) that has been trained to perform a variety of video analytics tasks. These video analytics tasks may include identification of elements 404 (e.g., 404-1 . . . 404-N) in a video feed (e.g., from a medical imaging system, a surveillance system, etc.). The elements 404 may be objects, persons, events, behaviors, activities, pathologies, diagnoses, conditions, etc. The input ML model 402 may be trained using a large dataset including video depicting these elements and may be labeled accordingly.

For example, the input ML model 402 may be extensively trained to identify various types of objects in video such as dogs, cats, vehicles, and humans. Of course, this is a non-limiting example, and it is contemplated that the input ML model 402 may be trained to perform any number of tasks and/or recognize any number of elements. Compression and specialization of this input ML model can then be performed as desired, to generate a smaller model (e.g., targeted ML model 412) that performs only a subset of the tasks that its trainer model (e.g., input ML model 402) is capable of performing.

In various embodiments, a user may intend to utilize an ML model to perform a specialized task. For instance, a user may want an ML model that will be used to identify one or more particular element from the elements 404 that input ML model 402 is capable of identifying. For example, say a user intended to utilize a particular ML model deployment to detect vehicles, such as by counting the number of vehicles that cross an intersection over the course of a day. In such a case, input ML model 402 is simply overpowered for this task and, while it may offer additional capabilities (e.g., the ability to identify additional particular elements such as dogs, cats, humans, etc.), these capabilities are ultimately not useful for the specialized task of detecting vehicles. Therefore, the portions of the input ML model 402 that facilitate the identification of non-vehicle elements (e.g., 404-1, 404-2, 404-N) would unnecessarily consume computational overhead in such a deployment. In architecture 400, model specialization process 248 may be used to produce a compressed and specialized model (e.g., targeted ML model 412) from the input ML model 402 that eliminates this unnecessary computational overhead while preserving model accuracy with respect to the specialized task.

Model specialization process 248 may utilize one or more inputs to configure the input training and/or deployment of such a targeted ML model 412. The inputs may be user-selected configuration parameters to be applied to the input ML model 402 and/or to the targeted ML model 412 and its training.

For example, the model specialization process 248 may obtain an indication of a specialized task 408 that the targeted ML model 412 is meant to perform. The specialized task may be a specific video analytics task that the targeted ML model 412 is to perform. In some instances, the specialized task may indicate a specific element (e.g., element 404-3) that the targeted ML model 412 will be used to identify when deployed. Continuing with the above vehicle counting example, the indication of the specialized task 408 may be an indication that the targeted ML model 412 is only required to detect vehicles when deployed.

In addition, model specialization process 248 may obtain an input such as input dataset 406. The input dataset 406 may include ground truth examples for the targeted ML model 412. For instance, in the example where the targeted ML model 412 is to be used for the specialized task of counting vehicles that cross an intersection, input dataset 406 may include video and/or images captured of the target intersection. The input dataset 406 may be a smaller and/or more focused (e.g., on the specialized task capability, the specific element, on the environment where the targeted ML model 412 will be deployed, etc.) dataset than the dataset that was used to train the input ML model 402.

Other inputs obtained by the model specialization process 248 may include an indication of a selected task for the targeted ML model 412. An indication of a selected task may include an indication of a specific video analytics technique to be performed by targeted ML model 412. Some examples of a selected task may include object detection, image classification, semantic segmentation, diagnosis, and activity recognition, among others.

In addition, inputs such as an indication of a model selection may be obtained by the model specialization process 248. An indication of a model selection may include an indication of a type of neural network structure to be used by the input ML model 402 and/or by targeted ML model 412. Some examples of a model selection may include a long short-term memory (LSTM) neural network, a residual network with 34 layers (ResNet34) neural network, a residual network with 18 layers (ResNet18) neural network, a mobile network (MobileNet) neural network, and a wide residual network (WideResNet) neural network, among others.

Model specialization process 248 may utilize one or more of the aforementioned inputs to automatically train and/or deploy the targeted ML model 412 from the input ML model 402. The deployed model (e.g., targeted ML model 412) will be compressed and/or specialized to a particular task relative to the input ML model 402. A compressed model may be one that is smaller than the input ML model 402, is less-computationally intensive to train and/or use than the input ML model 402, is less capable than the input ML model 402, can only perform a portion of the video analytics techniques that the input ML model 402 can, can only perform a portion of the elements that the input ML model 402 can, has fewer weights/layers/neurons than the input ML model 402, requires less memory to operate than the input ML model 402, and/or represents only a portion of the knowledge and/or capability of the input ML model 402. A specialized model may be one that has its capabilities specialized to the particular specialized task indicated by the indication of the specialized task 408 to the exclusion of other capabilities that were present in the input ML model 402 whence it was trained.

For example, the model specialization process 248 may, based on the aforementioned inputs, configure and/or implement a specializing and compressing knowledge distillation technique to input ML model 402. For instance, the input ML model 402 may be utilized as a teacher model to train the targeted ML model 412 as a student model that is more specialized and, therefore, compressed with respect to it. In the example where the targeted ML model 412 is to be used for the specialized task of counting vehicles that cross an intersection, this may mean that the model specialization process 248 only trains targeted ML model 412 to detect vehicles present within its input video. Model specialization process 248 may achieve this specialization and compression by trimming out the portions of the input ML model 402 devoted to the detection of other elements (e.g., dogs, cats, and humans) for training of the targeted ML model 412. This may result in not only a less computationally intensive targeted ML model 412, but also in reduced training times and resources to produce the targeted ML model 412.

As previously mentioned, model specialization process 248 may configure the specialization and compression based on the inputs it has obtained. For example, model specialization process 248 may identify, based on the inputs and/or analysis or knowledge of input ML model 402, a portion of an input machine learning model devoted to the indicated target specialization within the input ML model 402. Model specialization process 248 may then utilize only these portions to train the targeted ML model 412, which is consequently less computational resource intensive than that of the input ML model 402. Then, model specialization process 248 may deploy the trained targeted ML model (e.g., targeted ML model 412), which is compressed relative to the input ML model 402 and consequently is less computational resource intensive than that of the input ML model 402.

Additional inputs may be obtained and/or utilized by model specialization process 248 in training and/or deploying targeted ML model 412. An example of such an input may be dynamic data 410. Dynamic data 410 may include data associated with and/or characterizing a dynamically changing environment, such as the target deployment environment to which the new model is to be deployed. In some instances, the dynamic data 410 may be data characterizing changes to an environment to which the targeted ML model 412 is applied (e.g., changes to the physical environment captured in the video and/or images upon which the targeted ML model 412 operates). Model specialization process 248 may update data flows, tasks, models, and/or data as needed based on the environmental changes recognized in dynamic data 410. In one embodiment, dynamic data 410 may also be associated with a particular sampling rate, which may be selectable by a user (e.g., to reduce the amount of data by decreasing the sampling rate).

For example, say the intersection of interest in the above-outlined vehicle counting example is now undergoing construction or another traffic camera has been installed to record the traffic from a different angle. In such examples, model specialization process 248 may utilize this dynamic data to update and/or redeploy the compressed and specialized targeted ML model to account for the new or different data of dynamic data 410. This may include reconfiguring ground truths, data analysis, data relationships, predictive functions, model structures, etc. associated with the targeted ML model 412 to account for the environmental changes.

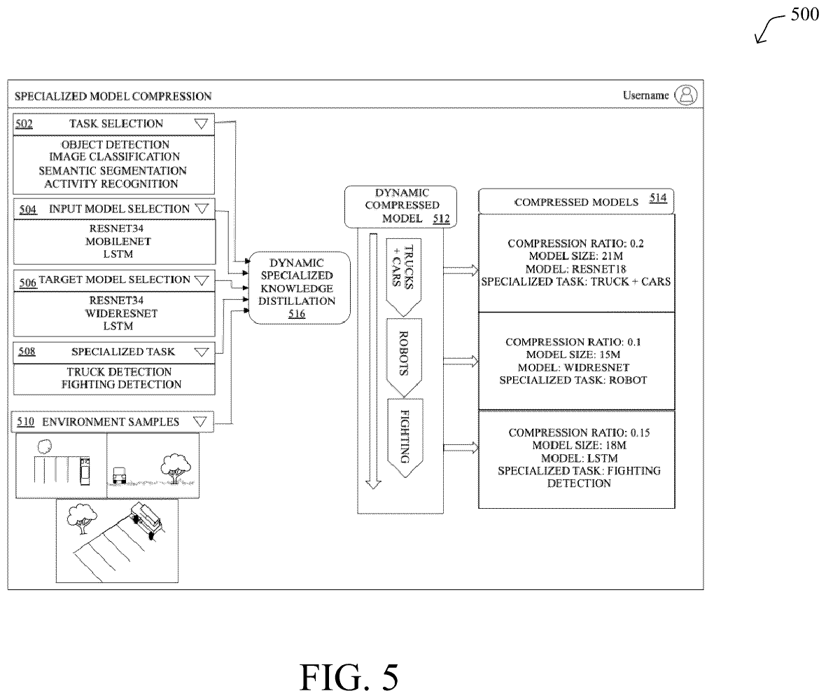

FIG. 5 illustrates an example of an interface 500 for the dynamic compression and specialization of a machine learning model, according to various embodiments. The interface 500 may be a user interface by which model-configuring inputs may be captured. Some of these inputs may be selectable, such as by selecting an element in a drop-down menu. Other inputs may be manually entered, uploaded, etc.

For example, a user may be prompted via interface 500 to provide one or more configuration parameters of the input ML model (e.g., teacher model, etc.) and/or the target ML model (e.g., student model, etc.) that they plan to deploy. In various embodiments, these configuration parameters may include a task selection 502. Task selection 502 may include a selection of a general type of task that the target ML model will be utilized to perform. Examples of tasks that may be selected in task selection 502 include object detection, image classification, semantic segmentation, activity recognition, among others. Task selection 502 may be used (e.g., by model specialization process 248) to compress and/or specialize the target ML model to a performance of a specific type or types of tasks.

In addition, a user may specify more specific types of tasks that the target ML model is to perform when deployed. For instance, the configuration parameters may include a specialized task selection 508. The specialized task selection may indicate the specific types of tasks, such as the detection of particular types of elements (objects, persons, events, behaviors, activities, pathologies, diagnoses, conditions, etc.) that the target ML model is to perform when deployed. Specialized task selection 508 may be used (e.g., by model specialization process 248) to further compress and/or specialize the target ML model to performance of a specific specialized task.

The configuration parameters may also include environment samples 510. Environment samples 510 may include input examples of the target deployment environment to which the target ML model is to be applied. In addition, the environment samples 510 may be dynamic data inputs characterizing the environment to which the target ML model is applied. Environment samples 510 may be used (e.g., by model specialization process 248) to further compress and/or specialize the target ML model to the deployment environment and/or to trigger an update to the target ML model.

In various embodiments, the configuration parameters may include an input model selection 504 and/or a target model selection 506. These configuration parameters may be used to specify a user-desired type(s) of both the input and/or target ML models. These configuration parameters may afford a user an opportunity to select the type of ML model that is best suited for the use case and/or the deployment environment (e.g., based on the capabilities of the executing device, etc.). Examples of ML model selections may include, LSTM, Resnet34, Resnet18, MobileNet, WideResNet, among others. Input model selection 504 and/or a target model selection 506 may be used (e.g., by model specialization process 248) to select and/or configure an input ML model and/or a target ML model. In various embodiments, the models made available for selection may be a procured set of recommended models determined by the model specialization process 248 to be most likely to produce a best performance level.

A dynamic specialized knowledge distillation 516 may be performed based on the configuration parameters obtained for the distillation. Consequently, one or more target models that are significantly compressed and specialized in comparison to the input model may be output. For example, model specialization process 248 may be used to perform compression and/or specialization operations to an input model to configure a dynamic compressed model 512. The dynamic compressed model 512 may include compressed models 514. The compressed models 514 may correspond to compressed portions of an input ML model used to train a target ML model to perform corresponding specialized tasks. Deploying the trained target ML models may include making these models available for use and/or applying the models to the targeted data (e.g., a video feed, etc.)

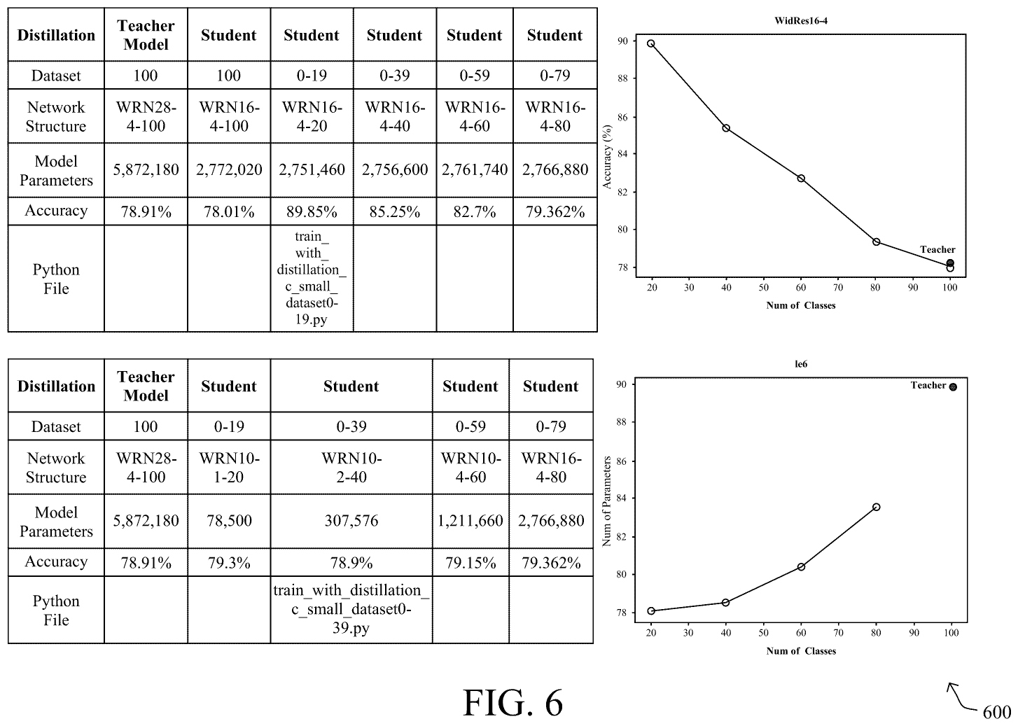

FIG. 6 illustrates examples of model testing results 600 for dynamically compressed and specialized machine learning models, according to various embodiments. As previously mentioned, model specialization process 248 may output one or more target models that are significantly compressed and specialized in comparison to the input model. Despite this compression, the specialization aspect may allow the target models to perform as accurately and/or more accurately with respect to the specialized task than the larger and more capable input model from which they were trained. For example, model testing results 600 indicate that this approach is quite capable of producing target ML models (e.g., student models) that exhibit suitable performance while being considerably compressed with respect to the input ML model (e.g., teacher model).

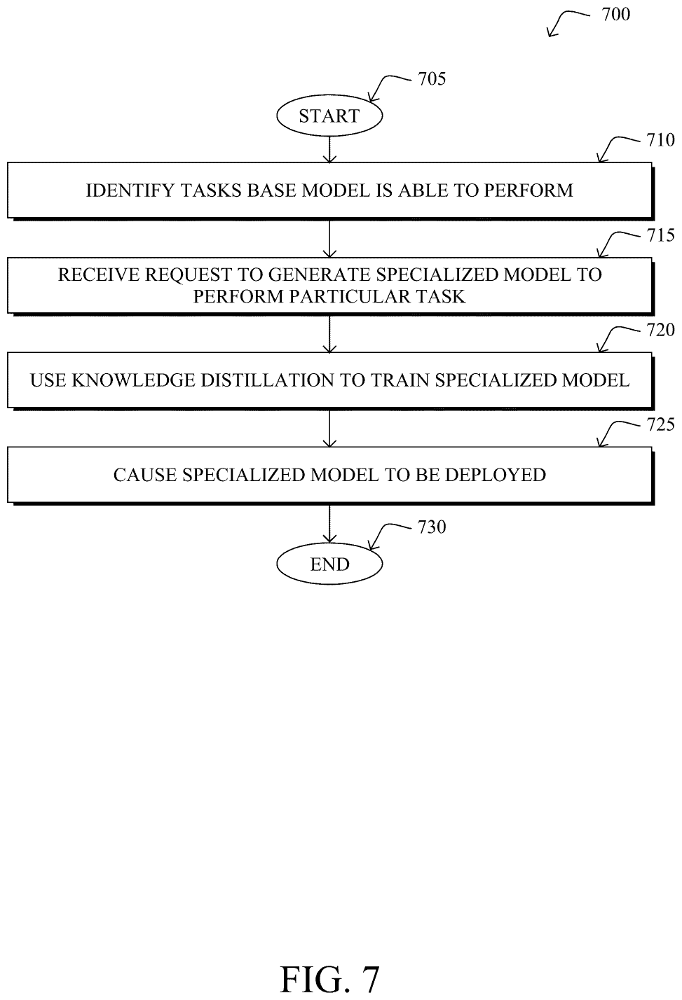

FIG. 7 illustrates an example simplified procedure (e.g., a method) for the dynamic compression and specialization of a machine learning model, in accordance with one or more embodiments described herein. For example, a non-generic, specifically configured device (e.g., device 200) may perform procedure 700 by executing stored instructions (e.g., model specialization process 248), such as to function as a student agent in accordance with the techniques herein. Procedure 700 may start at step 705, and continues to step 710, where, as described in greater detail above, a device may identify a plurality of tasks that a base machine learning model is able to perform. In various embodiments, the plurality of tasks comprises one or more of: object detection, image classification, sematic segmentation, or activity recognition.

At step 715, as detailed above, the device may receive, via a user interface, a request to generate a specialized model to perform a particular task for deployment to a target deployment environment. In some embodiments, the particular task comprises identifying a particular type of object or activity.

At step 720, the device may use knowledge distillation on the base machine learning model to train the specialized model to perform the particular task based on at least one of the plurality of tasks, as described in greater detail above. In various embodiments, the specialized model is a compressed form of the base machine learning model. In one embodiment, the device may also receive, via the user interface, a selection of a training dataset associated with the target deployment environment and train the specialized model based in part on the training dataset. In another embodiment, the device may also receive, via the user interface, a selected type of machine learning model whereby the device trains the specialized model as the selected type of machine learning model. In one embodiment, the selected type of machine learning model differs from that of the base machine learning model.

At step 725, as detailed above, the device may cause the specialized model to be deployed to the target deployment environment. In one embodiment, the device may do so directly by sending the specialized model to an execution node associated with the target deployment environment. In another embodiment, the device may do so indirectly by sending the specialized model to another device for forwarding to the execution node. In some embodiments, the device may also update the specialized model in response to a change in sensor data captured at the target deployment environment.

Procedure 700 then ends at step 730.

It should be noted that while certain steps within procedure 700 may be optional as described above, the steps shown in FIG. 7 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, introduce a system for the dynamic compression and specialization of a machine learning model. These techniques enable the dynamic compression and targeted specialization of a machine learning model to perform specific, defined tasks, while reducing the computational resource requirements over an input model without degrading the accuracy of the model relative to a specialized task.

While there have been shown and described illustrative embodiments for the dynamic compression and specialization of a machine learning model, it is to be understood that various other adaptations and modifications may be made within the spirit and scope of the embodiments herein. For example, while certain embodiments are described herein with respect to specific types of artificial intelligence development systems, the techniques can be extended without undue experimentation to other use cases, as well.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method comprising:
identifying, by a device, a plurality of tasks that a base machine learning model is able to perform;
receiving, at the device and via a user interface, a request to generate a specialized model to perform a particular task for deployment to a target deployment environment;
using, by the device, knowledge distillation on the base machine learning model to train the specialized model to perform the particular task based on at least one of the plurality of tasks; and
causing, by the device, the specialized model to be deployed to the target deployment environment.

2. The method as in claim 1, wherein the specialized model is a compressed form of the base machine learning model.

3. The method as in claim 1, wherein the plurality of tasks comprises one or more of: object detection, image classification, sematic segmentation, or activity recognition.

4. The method as in claim 1, wherein the particular task comprises identifying a particular type of object or activity.

5. The method as in claim 1, further comprising:
updating, by the device, the specialized model in response to a change in sensor data captured at the target deployment environment.

6. The method as in claim 1, further comprising:
receiving, at the device and via the user interface, a selection of a training dataset associated with the target deployment environment, wherein the device trains the specialized model based in part on the training dataset.

7. The method as in claim 1, further comprising:
receiving, at the device and via the user interface, a selected type of machine learning model, wherein the device trains the specialized model as the selected type of machine learning model.

8. The method as in claim 7, wherein the selected type of machine learning model differs from that of the base machine learning model.

9. The method as in claim 1, wherein causing the specialized model to be deployed to the target deployment environment comprises:
sending the specialized model to an execution node associated with the target deployment environment.

10. The method as in claim 1, wherein the specialized model takes video data as input to perform the particular task.

11. An apparatus, comprising:
a network interface to communicate with a computer network;
a processor coupled to the network interface and configured to execute one or more processes; and
a memory configured to store a process that is executed by the processor, the process when executed configured to:
identify a plurality of tasks that a base machine learning model is able to perform;
receive, via a user interface, a request to generate a specialized model to perform a particular task for deployment to a target deployment environment;
use knowledge distillation on the base machine learning model to train the specialized model to perform the particular task based on at least one of the plurality of tasks; and
cause the specialized model to be deployed to the target deployment environment.

12. The apparatus as in claim 11, wherein the specialized model is a compressed form of the base machine learning model.

13. The apparatus as in claim 11, wherein the plurality of tasks comprises one or more of: object detection, image classification, sematic segmentation, or activity recognition.

14. The apparatus as in claim 11, wherein the particular task comprises identifying a particular type of object or activity.

15. The apparatus as in claim 11, wherein the process when executed is further configured to:
update the specialized model in response to a change in sensor data captured at the target deployment environment.

16. The apparatus as in claim 11, wherein the process when executed is further configured to:
receive, via the user interface, a selection of a training dataset associated with the target deployment environment, wherein the apparatus trains the specialized model based in part on the training dataset.

17. The apparatus as in claim 11, wherein the process when executed is further configured to:
receive, via the user interface, a selected type of machine learning model, wherein the apparatus trains the specialized model as the selected type of machine learning model.

18. The apparatus as in claim 17, wherein the selected type of machine learning model differs from that of the base machine learning model.

19. The apparatus as in claim 11, wherein the apparatus causes the specialized model to be deployed to the target deployment environment by:
sending the specialized model to an execution node associated with the target deployment environment.

20. A tangible, non-transitory, computer-readable medium storing program instructions that cause a device to execute a process comprising:
identifying, by the device, a plurality of tasks that a base machine learning model is able to perform;
receiving, at the device and via a user interface, a request to generate a specialized model to perform a particular task for deployment to a target deployment environment;
using, by the device, knowledge distillation on the base machine learning model to train the specialized model to perform the particular task based on at least one of the plurality of tasks; and
causing, by the device, the specialized model to be deployed to the target deployment environment.
